(19) United States
(12) Patent Application Publication
(10) Pub. No.: US 2008/0285096 A1
(43) Pub. Date: Nov. 20, 2008

(54) Scanning System for Generating an Image

(76) Inventors: Chengwu Cui, Lexington, KY (US); Phillip Daniel Erwin, JR., Lexington, KY (US); Charles Brandon Langrel, Lexington, KY (US); Mark Lane Mayberry, Wilmore, KY (US); Stephen Ray Wilson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/748,664

(22) Filed: May 15, 2007

(51) Int. Cl. H04N 1/04

(52) U.S. Cl. 358/496; 358/474

(57) ABSTRACT

A scanning system for generating an image includes a scanning device configured to receive light reflected from a document and to output a signal corresponding to the received light to collect image data for use in generating an image. An automatic document feed system is configured to move the document from a position upstream of the scanning device toward a position downstream of the scanning device along a document feed path in proximity to the scanning device to allow the scanning device to receive light reflected from the document. A processor includes logic that compensates for changes in document movement past the scanning device using document motion data to reduce motion error induced image defects.

### TECHNICAL FIELD

The present application relates generally to scanning systems for collecting an image of a document and more particularly, to a scanning system capable of compensating for changes in document movement using document motion data to reduce motion error induced image defects.

### BACKGROUND

Digital copying, in which a digital image is obtained from a scanning device and then printed, involves a variety of factors that may compromise image quality. Scanning systems, such as those used in scanners, facsimile devices, copiers, multi-function peripherals (MFP), etc., usually capture the image of a document either by moving a scan head across the document or by moving the document across the scan head. A scan head is an optical sensing device used to scan an image. An automatic document feeder (ADF) may be used to move the document across the scan head. An image is formed when individual scan lines are stacked together assuming uniform motion and speed. In instances where an ADF is used to move the document, motion quality of the document can influence scanned image quality.

### SUMMARY

In an aspect, a scanning system for generating an image from image data includes a scanning device configured to receive light reflected from a document and to output a signal corresponding to the received light to collect the image data. An automatic document feed system is configured to move the document from a position upstream of the scanning device toward a position downstream of the scanning device along a document feed path in proximity to the scanning device to allow the scanning device to receive light reflected from the document. A processor includes logic that compensates for changes in document movement past the scanning device using document motion data to reduce motion error induced image defects.

In another aspect, a method of generating an image using a scanning system including a scanning device and an automatic document feed system is provided. The method includes delivering a document using the automatic document feed system from a position upstream of the scanning device toward a position downstream of the scanning device along a document feed path in proximity to the scanning device. Document motion data is generated by detecting motion of the document as the document is delivered from the upstream position toward the downstream position.

The details of one or more embodiments are set forth in the accompanying drawings and the description below. Other features, objects and advantages will be apparent from the description and drawings and from the claims.

### BRIEF DESCRIPTION OF THE DRAWINGS

FIG. 1 is diagrammatic side elevational view of an embodiment of a system and method for scanning and collecting an image from a document;

FIG. 2 is a functional block diagram of an embodiment of a single linear array of photodiodes;

FIG. 3 is a flow chart of an embodiment of a method of generating an image;

FIG. 4 is a timing diagram generated using the method of FIG. 3;

FIG. 5 is another timing diagram where a uniform start of scan line pulses is used; and

FIG. 6 illustrates an embodiment of a process of scan line position rematch based on the stored motion distances.

### DETAILED DESCRIPTION

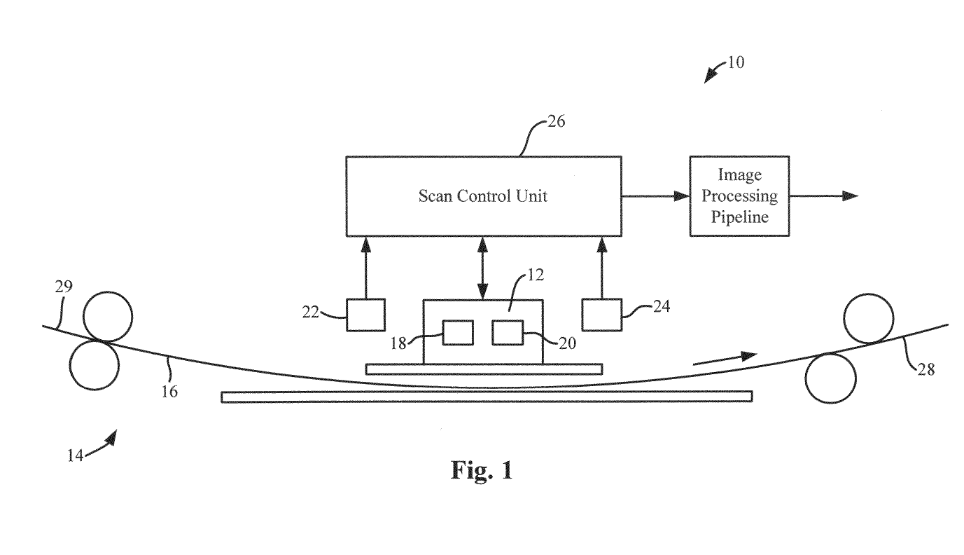

Referring to FIG. 1, a scanning system 10 (e.g., for use in a copier, scanner, facsimile device, MFP, etc.) includes a scanning device 12 (such as a scan head) and an automatic document feed system (represented generally by element 14) for delivering a document 16 past the scanning device 12. The scanning device 12 is stationary, providing a fixed scanning position. The document 16 does not remain stationary but rather continues to move during a scanning operation. A configuration where the scanning position is fixed and the document moves is sometimes referred to as a flow scan configuration. In some embodiments, a device may have both a flow scan configuration and a fixed scan configuration where the document is stationary and the scanning device moves.

As shown diagrammatically by FIG. 1, scanning device 12 includes a light source 18 and a light sensor 20. Light source 18 illuminates the document 16 while the light sensor 20 receives light reflected from the document and generates a signal corresponding to the received light. An upstream motion sensor 22 is located above the document feed path and at an upstream side of the scanning device 12. A downstream motion sensor 24 is located above the document feed path and at a downstream side of the scanning device 12. The upstream motion sensor 22 and the downstream motion sensor 24 generate motion data indicative of motion (such as velocity) of the document 16 thereby.

It may be desirable to locate the motion sensors 22 and 24 as near to the light sensor 20 as possible. Thus, in some embodiments, the motion sensors 22 and 24 (or a single motion sensor) are incorporated into the scanning device 12 itself. In the illustrated embodiment, however, motion sensors 22 and 24 are located at opposite sides of the scanning device 12 to ensure paper motion is always being sensed during the scanning operation due to the limited document length. As the document 16 passes by the motion sensors 22 and 24, at least one motion sensor will detect and send motion data to the scan control unit 26. As will be described in greater detail below, the scan control unit 26 is capable of using the motion data to adjust image data generated using the scanning device 12 in generating the image. The motion data can be used to compensate for changes in document movement past the scanning device 12 to reduce motion error induced image defects.

Motion sensors 22 and 24 may include integrated one or two dimensional image arrays or processors to detect document 16 motion by computing correlation of reflected images of the document at predefined time intervals. The integrated motion sensors 22 and 24 may include CMOS sensor arrays and integrated circuits for computing the one or two-dimensional motions of document 16 based on more than one image frame of the document 16 focused directly onto the sensor array.

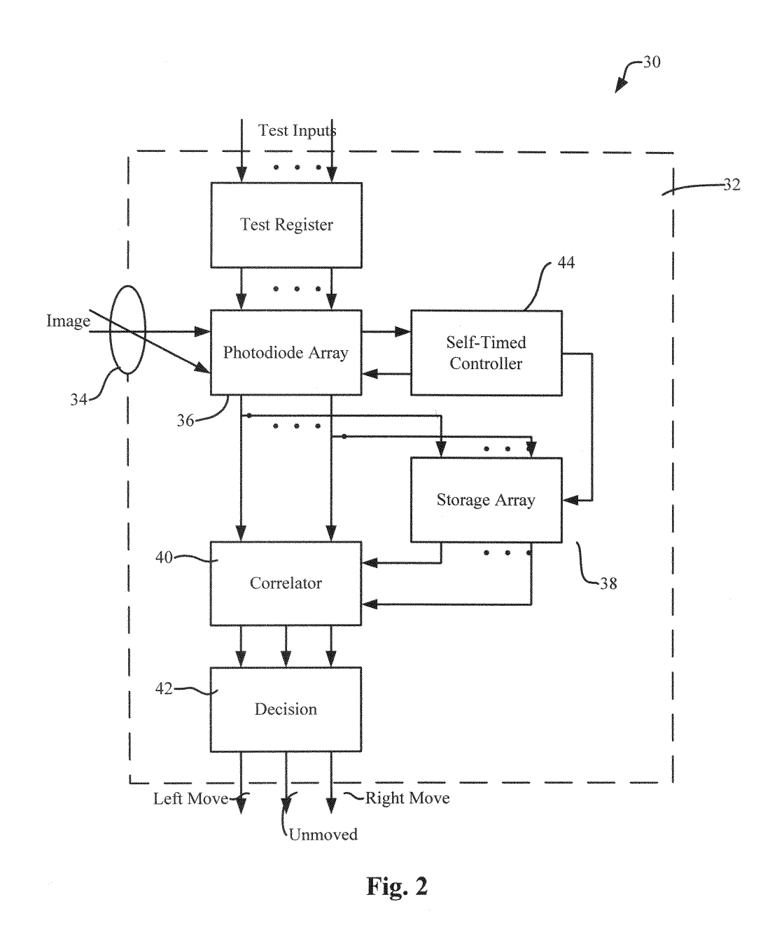

There are various ways of calculating motion velocity based on correlation of two frames of images of document 16 at a predefined interval of time by a digital processor. Referring to FIG. 2, for example, motion sensor 22 or 24 may be an optical motion detector 30, which includes a CMOS integrated circuit chip 32 and a lens 34 to project an image of the document 16 onto the circuit chip. An array of photodiodes 36 are used to detect a light pattern image. A storage array 38 is used for storing the image. A correlator 40 is used to compute a correlation between a stored image and a current one. Decision circuitry 42 is used to determine the direction of motion and a self-timed controller 44 is used to sequence the system. Additional details of motion detector 30 are described in U.S. Pat. No. 4,631,400, titled “Correlating Optical Motion Detector,” filed Jan. 20, 1984, the details of which are incorporated by reference as if fully set forth herein. Additional systems and methods for motion computation are described in Higgins et al., “Pulse-Based 2-D Motion Sensors,” IEEE Transactions on Circuits and Systems: Analog and Digital Signal Processing, Vol. 46, No. 6 (1999), the content of which is hereby incorporated by reference as if fully set forth herein.

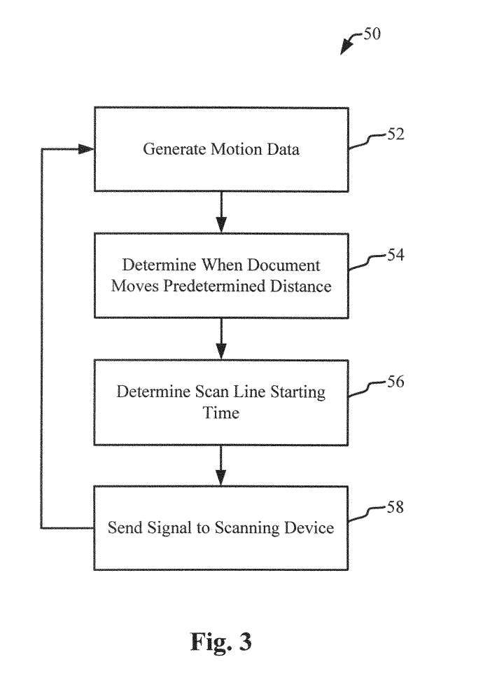

Referring to FIG. 3, a method 50 of generating a scanned image includes generating motion data using one or more of the motion sensors 22 and 24 that is indicative of document 16 motion (block 52). At block 54, the scan control unit 26 (or other processing unit) uses a processor, the motion data and a known distance to determine when the document 16 moves the known distance. The known distance may correspond to a desired distance between scan lines which is dependent on the scan resolution along the document 16 motion direction. Based upon the calculations at block 54, a scan line starting time is determined at block 56. Based on the scan line starting time determined at block 56, the scan control unit 26 signals the scanning device 12 to scan a specific line of the document 16 at block 58. Method 50 is repeated until the entire document 16 is scanned.

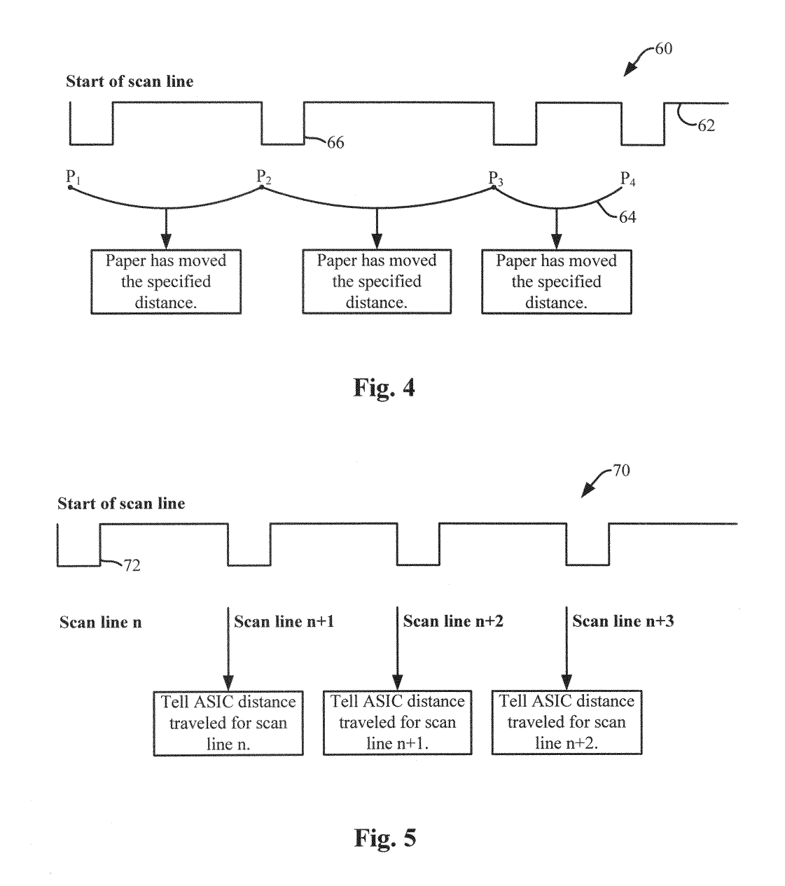

FIG. 4 represents a timing diagram 60 generated using the method 50 of FIG. 3, wherein the output generated by one or both of the motion sensors 22 and 24 is used to control image data collection. Timing diagram 60 includes a plot 62 diagrammatically representing scan intervals and a plot 64 diagrammatically representing paper movement versus time. A scanning operation may be initiated upon detection of the leading edge 28 of the document 16 using motion sensor 22. Motion data generated using the motion sensor 22 can be used to determine a distance the document 16 has traveled based on the instant velocity of the document 16. Once it has been determined that the document 16 has traveled a predetermined distance (e.g., from P₁ to P₂), the scan control unit 26 signals the scanning device 12 to collect a scan line as represented by pulses 66.

As can be seen, the scan control unit 26 can signal the scanning device 12 to collect scan lines at different time intervals to accommodate variations in document velocities. For example, although the distances between P₁ and P₂ and P₂ and P₃ and P₃ and P₄ are the same, it takes the document 16 longer to travel from P₂ to P₃ due to, for example, a lower document velocity at P₂ than at P₁. Likewise, it takes document 16 lesser time to travel from P₃ to P₄ due to, for example, a higher document velocity at P₄ than P₃. Use of the motion sensors 22 and 24 can allow the scan control unit 26 to adjust scan line collection to accommodate the variation in document velocity as the document 16 passes by the scanning device 12. While the distances between P₁ and P₂ and P₂ and P₃ are described as being the same, in some embodiments, they may be different. In some embodiments, the scanning device 12 may include an electronic shutter to adjust exposure time accordingly. Preferably, the average line exposure time corresponding to the target speed of the document 16 is sufficiently greater than the data extraction or exposure time of the image data so that the likelihood for the start of scan line pulses to come too quickly is low.

Referring now to FIG. 5, timing diagram 70 represents an alternative embodiment where a uniform start of scan line pulses 72 is used. In this embodiment, the scan control unit 26 (e.g., using a microprocessor implemented image processing application-specific integrated circuit (ASIC)) signals the scanning device 12 to collect scan lines at uniform time intervals. The collected image data and document velocity is recorded and time stamped, for example, using the microprocessor which includes an integral timer or timing scheme stored in memory. The motion sensors 22 and 24 and motion detection logic are used to determine how much the document 16 moved between the time stamp intervals.

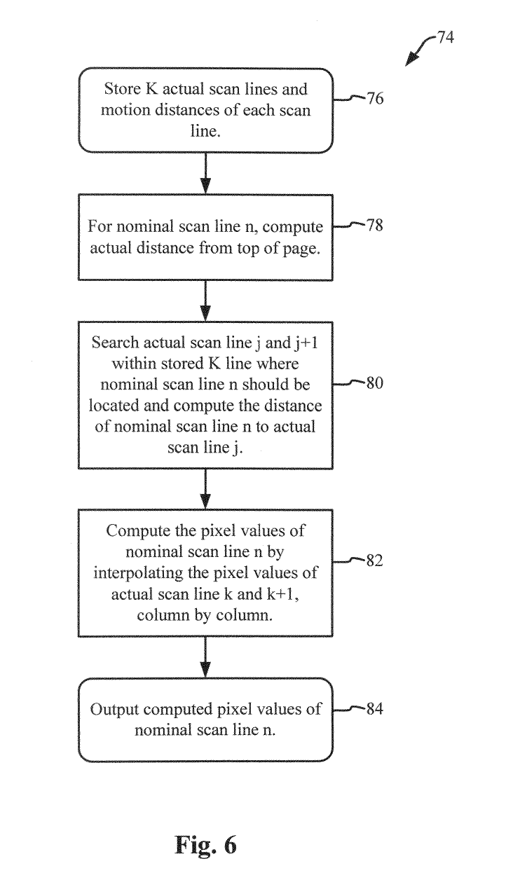

In some embodiments, the image processing ASIC corrects motion induced errors based on the distance the document moved using the motion data. Referring now to FIG. 6, a process 74 of scan line position rematch by the ASIC based on the stored motion distances for each scan line is shown. At block 76, K actual scan lines and motion distances of each scan line are stored. K should be a reasonable number, such as 10, depending on hardware design. At block 78, for nominal scan line n, an actual distance from the leading edge 28 of the document is calculated. Searching actual scan line j and j+1 within stored K line where nominal scan line n should be located and computing the distance of nominal scan line n to actual scan line j occurs at block 80. The pixel values of nominal scan line n are computed at block 82 by interpolating the pixel values of actual scan line k and k+1, column by column. The computed pixel values of nominal scan line n are then output (block 84).

It is to be clearly understood that the above description is intended by way of illustration and example only and is not intended to be taken by way of limitation. For example, the motion sensors 22 and 24 may be located at a position other than above the document feed path as shown in FIG. 1, such as below the feed path in a manner that allows the motion sensors to detect and send motion data to the scan control unit 26. The motion sensors 22 and 24 may be used to detect the leading and trailing edges 28 and 29 of the document 16 (FIG. 1). Other motion sensors, such as laser tracking devices or mechanical motion sensors such as a track ball combined with an optical sensor, may be used. Other changes and modifications could be made.

What is claimed is:

1. A scanning system for generating an image from image data, comprising:
a scanning device configured to receive light reflected from a document and to output a signal corresponding to the received light to collect the image data;
an automatic document feed system configured to move the document from a position upstream of the scanning device toward a position downstream of the scanning device along a document feed path in proximity to the scanning device to allow the scanning device to receive light reflected from the document; and
a processor that compensates for changes in document motion past the scanning device using document motion data to reduce motion error induced image defects in the collected image data.

2. The scanning system of claim 1, further comprising a motion sensor arranged and configured to detect motion of the document as the document moves from the upstream position toward the downstream position and to output document motion data indicative of the detected motion.

3. The scanning system of claim 1, further comprising a scan control unit that controls the collection of image data using the document motion data.

4. The scanning system of claim 3, wherein the document motion data is indicative of velocity of the document at a point in time.

5. The scanning system of claim 3, wherein the processor determines a distance the document has moved using the document motion data and wherein the scan control unit signals the scanning device to collect the image data once the processor determines that the document has moved a predetermined distance.

6. The scanning system of claim 1, comprising:
a first motion sensor located adjacent the document feed path and at an upstream side of the scanning device that generates document motion data; and
a second motion sensor located adjacent the document feed path and at a downstream side of the scanning device that generates document motion data.

7. The scanning system of claim 6, wherein at least one of the first and second motion sensors includes a CMOS integrated circuit for use in generating the document motion data.

8. The scanning system of claim 1, wherein the processor is implemented in an application-specific integrated circuit that signals the scanning device to collect image data at substantially uniform intervals.

9. The scanning system of claim 1 wherein the processor includes an integral timer to associate at least one timestamp with the collected image data.

10. A method of generating an image of a document using a scanning system including a scanning device and an automatic document feed system, comprising:
receiving a document via the automatic document feed system from a position upstream of the scanning device toward a position downstream of the scanning device along a document feed path in proximity to the scanning device; and
generating document motion data by detecting motion of the document as the document is received from the upstream position toward the downstream position.

11. The method of claim 10, further comprising compensating for changes in document motion using the document motion data to reduce motion error induced image defects.

12. The method of claim 10, further comprising signaling the scanning device to collect image data by receiving light reflected from the document and to output a signal corresponding to the received light for use in generating image data.

13. The method of claim 12, further comprising processing the document motion data for determining a distance the document has moved using a processor.

14. The method of claim 13, further comprising signaling the scanning device to collect the image data once the processor determines that the document has moved a predetermined distance.

15. The method of claim 10, further comprising:
generating document motion data at a first motion sensor located adjacent the document feed path and upstream of the scanning device; and
generating document motion data at a second motion sensor located adjacent the document feed path and downstream of the scanning device.

16. The method of claim 10, further comprising signaling the scanning device to collect image data at substantially uniform intervals using a processor implemented in an application-specific integrated circuit.

17. The method of claim 10, further comprising associating a timestamp with the document motion data using an integral timer.

18. The method of claim 16, further comprising correcting motion error induced image defects by re-matching a nominal scan line position with an actual scan line position of a scanned image.
